(19) United States
(12) Patent Application Publication
(10) Pub. No.: US 2004/0101693 A1
(43) Pub. Date: May 27, 2004

(54) Plastic compound, use of said plastic compound, and product comprising said plastic compound

(76) Inventors: Tobias Erny, Muenchen (DE); Gabriele Preu, Munchen (DE)

Correspondence Address: YOUNG & THOMPSON, 745 SOUTH 23RD STREET 2ND FLOOR, ARLINGTON, VA, 22202

(21) Appl. No.: 10/275,569

(22) PCT Filed: Apr. 11, 2001
(86) PCT No.: PCT/DE01/01429

(30) Foreign Application Priority Data
May 8, 2000 (DE) 100 22 261.7

(51) Int. Cl. B32B 17/06; C03C 14/00

(52) U.S. Cl. 428/426; 428/429; 501/32

(57) ABSTRACT

A plastic compound (1) comprises at least one organic starting compound (2) of at least one ceramic material (5), and at least one inorganic starting material (3) of the ceramic material (5), the ceramic compound comprising a glass material (4). By subjecting the plastic compound to pyrolysis an electrically insulating glass ceramic (6) having relatively high mechanical stability is obtained. The plastic compound is used as cable sheathing of a cable core. The cable sheathing allows to preserve the functionality of the cable in the case of a cable fire.

The invention relates to a plastics mass comprising at least one organic starting compound of at least one ceramic material and at least one inorganic starting compound of the ceramic material. In addition to the plastics mass, the invention also proposes a use of the plastics mass and a product which includes the plastics mass.

A plastics mass of this type is known, for example, from P. Greil et al. in Advanced Composite Materials, 2nd Int. Ceram. Sci. and Technol. Congress, Orlando, 1990, pp. 43-49, and from DE 39 26 077 A1. The plastics mass is used to produce a ceramic material. The plastics mass can be ceramicized and functions as a precursor of the ceramic material. The plastics mass contains an organic starting substance and an inorganic starting substance of the ceramic material. Thermal decomposition (pyrolysis) of the plastics mass at a temperature from the range from 800° C. to 1200° C. leads to the formation of the ceramic material. A base substance for the plastics mass, of which the plastics mass essentially consists, is a polyorganosiloxane (polysiloxane, silicone [R₂(SiO)]ₓ). The polyorganosiloxane is the organic starting compound of the ceramic material. The base material contains pulverulent titanium. Titanium is the inorganic starting compound of the ceramic material. By way of example, the ceramic material titanium carbide (TiC) is formed by pyrolysis of the plastics mass. First of all, a more or less porous, amorphous framework (matrix) comprising silicon dioxide (SiO₂) and/or silicon oxycarbide (SiOₓC_{y}) is formed. As the process continues, a type of sintering takes place in which, by way of example, the ceramic material titanium carbide is formed from silicon oxycarbide and titanium.

Depending on a composition of the plastics mass and a temperature at which the pyrolysis is carried out, different ceramic materials are formed. In addition to titanium carbide, it is also possible for silicon carbide (SiC), titanium silicide (TiSi₂, Ti₅Si₃) and/or silicon dioxide (SiO₂) to be formed as ceramic material. As a result of, for example, a metal boride, such as tantalum boride (TaB₂), being added, it is possible to ensure virtually zero shrinkage during the pyrolysis. A dimension of a ceramic body made from the ceramic material after the pyrolysis substantially corresponds to a dimension of a plastic body made from the ceramic compound prior to the pyrolysis.

EP 0 708 455 A1 has disclosed a flame-retardant plastics mass which can be ceramicized. The plastics mass is used as the cable sheath of a cable and ensures that the cable continues to function in the event of a fire in the cable or a fire in the vicinity of the cable. The plastics mass is pyrolyzed as a result of an increase in temperature caused by the fire. The ceramic material which is formed as a result ensures that a cable core of the cable is electrically insulated. The base material of the plastics mass is a polyorganosiloxane, which functions as the organic starting compound of the ceramic material. Aluminum oxide (Al₂O₃) is admixed with the base material as the inorganic starting compound of the ceramic material. The ceramic material formed by the pyrolysis at a temperature of up to 1200° C. is, for example, mullite (Al₂O₃×SiO₂). As described above, the mullite is formed via a porous, amorphous framework of silicon dioxide.

On account of the organic and inorganic starting compounds used, and on account of the way in which the ceramic material is formed, a porous microstructure which includes the ceramic material is formed during the pyrolysis of the ceramic mass. On account of the porous microstructure, an assembly comprising the cable core and the ceramic material which surrounds the cable core, and which is formed during or after a cable fire can only be subjected to a low mechanical load. The assembly may be permanently damaged by the mechanical load, and consequently it is difficult for the cable to function when it is subject to both thermal and mechanical loads. To avoid this problem, the cable is mechanically reinforced with the aid of a reinforcing fabric. The reinforcing fabric consists of a noncombustible mineral material.

It is an object of the present invention to provide a plastics mass which, when the plastics mass is pyrolyzed, forms a microstructure with a ceramic material which has a mechanical load-bearing capacity which is improved compared to the prior art.

To achieve this object, the invention proposes a plastics mass comprising at least one organic starting compound of at least one ceramic material and at least one inorganic starting compound of the ceramic material. The plastics mass is characterized in that there is at least one glass material for forming a glass-ceramic which includes the ceramic material.

A second aspect of the invention provides for the plastics mass to be used to produce a glass-ceramic. The plastics mass functions as a precursor of the ceramic material or the glass-ceramic. The glass-ceramic is produced primarily by pyrolysis of the ceramic mass. The glass-ceramic is the microstructure comprising the ceramic material. A property of the microstructure, for example, the mechanical load-bearing capacity, can be adjusted very variably by means of the glass content of the glass-ceramic.

The glass-ceramic results in the mechanical load-bearing capacity being provided without the need for a reinforcing fabric. It is advantageously ensured that the glass material is not volatile at the temperature at which the pyrolysis takes place and is available for forming the glass-ceramic. By way of example, a viscosity of the glass material in the form of glass is so low that it does not flow out of the ceramic mass.

A further aspect of the invention provides an electrical engineering product which includes the plastics mass. The plastics mass is used to electrically insulate the product. The plastics mass and the electrical engineering product form an assembly. In particular, the product is a cable and the plastics mass is a cable sheath of the cable. Pyrolysis of the plastics mass, which may occur, for example, in the event of a fire in the cable, results in the formation of a glass-ceramic which takes over the function of the plastics mass. The glass-ceramic is used to electrically insulate the electrical engineering product. The fact that the glass-ceramic can be subjected to mechanical load also ensures that the assembly of electrical engineering product and electrical insulation is mechanically stable. Otherwise, any electrical engineering product whose operation has to be reliably ensured even in the event of a fire is conceivable. This product may be a single component, for example a capacitor, or an entire electric circuit.

The ceramic material or the glass-ceramic is formed at a temperature of, for example, 800° C. to 1200° C. This leads to pyrolysis of the organic and/or inorganic starting compound of the ceramic material, with a reactive intermediate stage (reactive intermediate product) being formed. As the process continues, the ceramic material is formed from the reactive intermediate stage in a type of sintering operation.

In particular, a plurality of ceramic materials may form. The ceramic material is a constituent of the glass-ceramic. In addition to the ceramic material, the glass-ceramic also includes a glass phase.

The organic starting compound and/or the inorganic starting compound and/or the glass material each function as a reactive filler in the plastics mass. The organic starting compound is in particular an organometal compound. By way of example, the organic starting compound is an organosilicon polymer such as polysilane, polycarbosilane, polysilazane or polyorganosiloxane. A blend of various polymers or a copolymer of various organometal and non-organometal monomers is also conceivable. The organic starting compound may be in polymerized or monomeric form.

Monomeric means that the organic starting compound is uncrosslinked, and polymerized means that the organic starting compound is completely or partially crosslinked. The organic starting compound may form the base material of the plastics mass. It is also conceivable for the organic starting compound to be admixed to the base material of the plastics mass. As an admixture, it is in particular also conceivable for the organic starting compound to be an organometal salt or an organometal complex.

The inorganic starting compound may already be in a reactive form. The inorganic starting compound may be in the form of a salt or may itself be in the form of a ceramic material. By way of example, the inorganic starting compound is aluminum oxide or silicon carbide (SiC). As is also true of the organic compound, it is also conceivable for a reactive intermediate stage to be formed from the inorganic starting compound as a result of energy being supplied, and for this reactive intermediate stage to react with the organic starting compound or the reactive intermediate stage from the pyrolysis of the organic starting compound. By way of example, the inorganic starting compound is aluminum hydroxide (Al(OH)₃). The supply of energy results in the formation of aluminum oxide from aluminum hydroxide, with water being released. It is also conceivable for the inorganic starting compound to be an organometal salt. The organometal salt can therefore act as an organic and/or inorganic starting compound.

As described in the introduction, a microstructure which only includes the ceramic material may be highly porous. To ensure sufficient mechanical stability of the microstructure, a glass material is admixed with the plastics mass. The glass material is used to form a glass-ceramic with the ceramic material. The glass material has the object of compacting the starting compounds and/or intermediate products of the ceramic material through viscous flow even at a temperature which is below the temperature at which the ceramic material is formed.

The glass material may be directly in glass form. However, it is also conceivable for the glass material to be a glass precursor from which the glass is formed during the pyrolysis of the plastics mass. The glass precursor which is used to form the glass, is, for example, an alkali metal or alkaline-earth metal carbonate, a corresponding hydroxide or similar compound. An increase in temperature leads to a corresponding oxide being formed from a carbonate or hydroxide, and this oxide is used to form the glass or a glass phase of the glass-ceramic.

In a particular configuration, the organic starting compound is a polyorganosiloxane. By way of example, silicon dioxide is formed by pyrolysis as a reactive intermediate stage. If aluminum oxide is the inorganic starting compound, the pyrolysis of the ceramic mass leads to the formation of a ceramic material, in the form of an aluminosilicate or aluminum silicate, in a type of sintering operation from the silicon dioxide and the aluminum oxide. The aluminum silicate is, for example, mullite.

In a particular configuration, the glass material and/or the glass-ceramic include(s) a glass with a glass point (glass transition temperature) Tg, which is higher than a decomposition temperature Tz of the organic starting compound of the ceramic material. At a temperature above the glass point, the glass is visco-elastic, and at a temperature below the glass point the glass is brittly elastic. The glass material is, for example, a borosilicate glass with a glass point of approx. 560° C. The organic starting compound in the form of a polyorganosiloxane has a decomposition temperature Tz, of, for example, below 500° C.

In a particular configuration, the ceramic material and/or the glass-ceramic, within a defined temperature range, have/has a greater specific volume and/or a higher coefficient of thermal expansion than the organic starting compound and/or inorganic starting compound of the ceramic material. The basic consideration in this context is that in many cases the pyrolysis of a plastic involves a contraction in volume. The contraction in volume leads to an internal mechanical load for example in the assembly of cable core and cable sheath. The contraction in volume is counteracted by the formation of the ceramic material, which is associated with an expansion in volume. The internal mechanical load is reduced. An additional advantage results if the ceramic material has a high coefficient of thermal expansion. By way of example, a temperature increase in kyanite may lead to a change in volume of up to 14%. This contributes to additional stabilization of the assembly of cable core and cable sheath or of the insulation of the cable core.

In particular, the ceramic material and/or the inorganic starting compound of the ceramic material and/or the glass material include(s) at least one substance which is selected from the group consisting of aluminum, barium, boron, carbon, calcium, potassium, magnesium, sodium, nitrogen, oxygen, silicon and/or zirconium. The inorganic starting compound is in particular in the form of an oxide. It is also conceivable for the inorganic starting compound to be in the form of a carbonate or hydroxide and only to be converted into the oxidic form as a result of energy being supplied (an increase in temperature). By way of example, the reaction of the carbonate to form an oxide takes place endothermically. The reaction is accelerated by the supply of energy. As a result, energy is extracted from an overall system comprising plastics mass which is being pyrolyzed and, for example, the cable core. Moreover, adding a carbonate or hydroxide, which in each case does not necessarily have to be involved in the formation of the ceramic material, has the advantage that within a low-temperature range, i.e. a range below the temperature at which the ceramic material is formed, the combustibility of the plastics mass can be reduced and therefore the thermal stability of the cable sheath can be increased.

In a particular configuration, the inorganic starting compound and the glass material are an inorganic phase of the plastics mass. The glass material forms from 10% by volume to 50% by volume inclusive of the inorganic phase.

In a further configuration of the invention, the glass material includes the inorganic starting compound of the ceramic material. By way of example, it is conceivable for the inorganic starting compound to be incorporated in glass. The glass material thus contributes directly to the formation of the ceramic material.

In a particular configuration, the glass material is a powder. In particular, the glass material is a glass powder. Powder has a large reactive surface area which is available for the formation of the glass-ceramic. Moreover, it is relatively easy to distribute homogeneously within the plastics mass. The pyrolysis of this plastics mass leads to the formation of a homogenous glass-ceramic. Ceramic phases and glass phases of the glass-ceramic are homogeneously distributed.

In a particular configuration, the ceramic material is a silicate. In particular, the silicate is selected from the group consisting of andalusite, celsian, cordierite, kyanite, mullite and/or silimanite. At temperatures of from 1000° C. to 1200° C., these silicates are formed from silicon dioxide, the decomposition product of polyorganisiloxane, and aluminum oxide. The silicates have a larger specific volume than silicon dioxide and aluminum oxide. An expansion in volume occurs during the formation of the silicates. Moreover, it is conceivable for a phase transition from a ceramic material into a different ceramic material to take place at a defined temperature. This phase transition may be associated with an increase in volume.

In addition to the organic starting compound, the inorganic starting compound and the glass material, the ceramic mass may also contain a (reactive) filler, which leads, for example, to a reduction in a thermal load on the assembly comprising cable sheath and cable core in the event of a fire. An example of a filler of this type is SiC and/or AlN. These fillers are distinguished by a high coefficient of thermal conductivity.

To summarize, the invention results in the following important advantages:

On account of the composition of the plastics mass, the pyrolysis of the plastics mass results in a glass-ceramic (microstructure) which can be exposed to a relatively high mechanical load.

The essential constituent with regard to the high mechanical load-bearing capacity of the microstructure is the glass phase of the glass-ceramic or the glass material used to form the glass-ceramic. Before the ceramic material is formed, the glass material leads to compacting of the starting compound and/or of the intermediate products of the ceramic material as a result of viscous flow.

The composition of the plastics mass may be selected in such a way that during the pyrolysis there is overall no significant change in volume (zero shrinkage). The contraction in volume which takes place during the pyrolysis of the base material of the plastics mass is compensated for by the expansion in volume which takes place during the formation of the ceramic material.

On account of the mechanic and electrical properties of the glass-ceramic which can be produced from the plastics mass, the plastics mass can be used as FRNC (flame-retardant non-corrosive) cable sheathing. In the event of a fire, in which temperatures of over 1000° C., for example, may occur, it is ensured that the cable remains able to function.

The plastics mass, the use of the plastics mass and an electrical engineering product which includes the plastics mass are described in more detail with reference to an exemplary embodiment and the associated figures. The associated figures are diagrammatic and not to scale.

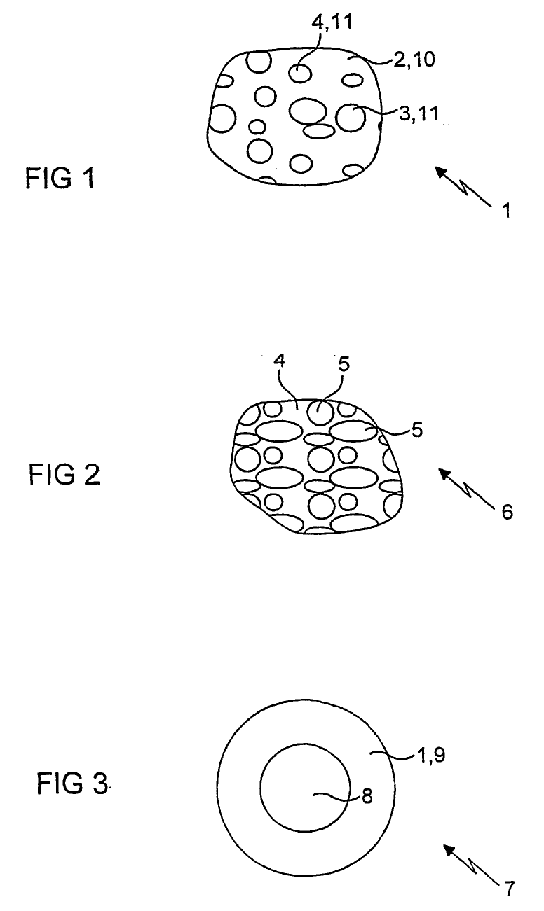

FIG. 1 shows a detail of a plastics mass.

FIG. 2 shows a detail of a glass-ceramic which has been produced from the plastics mass.

FIG. 3 shows a cross section through an electrical engineering product which includes the plastics mass.

The plastics mass 1 has an organic starting compound 2 of at least one ceramic material 5, at least one inorganic starting compound 3 of the ceramic material 5 and a glass material 4. The glass material 4 is used to form the glass-ceramic 6 with the ceramic material 5. The ceramic mass 1 consists of 40% by volume of an organic phase 10 and 60% by volume of an inorganic phase 11. The organic phase 10 consists of crosslinked dimethylpolysiloxane ([CH₃)₂(SiO)]ₓ). Dimethylpolysiloxane is the base material of the ceramic mass 1 and, at the same time, the organic starting compound 2 of the ceramic material 5. It has a decomposition temperature Tz of below 500° C. The inorganic phase 11 has the following composition: silicon carbide (20% by volume), aluminum hydroxide (30% by volume), aluminum oxide (20% by volume) and borosilicate glass (30% by volume). The borosilicate glass is the glass material 4. It has a glass point Tg of approximately 560° C. Silicon carbide, aluminum hydroxide and aluminum oxide are the inorganic starting compounds 3 of the ceramic material 5.

To produce the ceramic mass 1, the inorganic starting compounds 3 are milled for three hours with acetone in an attritor mill. Zirconium oxide beads function as the milling medium. The result is a powder mixture comprising the inorganic starting compounds 3 and the glass material 4, which is dried. The powder mixture is mixed with uncrosslinked or partially crosslinked dimethylpolysiloxane with a Shore hardness 45 by means of a double-Z kneader to form a homogenous blend. The plastics mass 1 is formed from the blend in a free-radical polymerization reaction with the aid of dicumyl peroxide as catalyst.

The plastics mass 1 is used to produce a glass-ceramic 4. To do this, the ceramic mass is heated to 1100° C. The glass-ceramic 6 forms by pyrolysis of the plastics mass 1 and/or pyrolysis of the organic starting compound 2, followed by sintering. The glass-ceramic 6 includes the following ceramic materials 5: mullite, sillimanite and silicon dioxide.

Alternatively, the plastics mass 1 is used as the electrical insulation of an electrical engineering product in the form of a cable core 8. For this purpose, the blend of uncrosslinked dimethyl-polysiloxane 2 and powder mixture of inorganic starting compounds 3 and glass material 4 is extruded onto the cable core 8 and crosslinked. The result is the cable 7 with the cable sheath 9 comprising the plastics mass 1 of the cable core 8. The cable 7 is used as an FRNC cable. The cable sheath 9 can be ceramicized in a dimensionally stable manner to form the glass-ceramic 6 while maintaining its function at up to 1150° C. Ceramicization of the plastics mass 1 leads to a glass-ceramic 6 which has a sufficient electrical insulation capacity and mechanical load-bearing capacity. Additional aging of the assembly of glass-ceramic 6 and cable core 8 at 1150° C. does not result in any further change in weight. The glass-ceramic 6 includes the ceramic materials 5 mentioned above.

1. A plastics mass (1) comprising
at least one organic starting compound (2) of at least one ceramic material (5), and
at least one inorganic starting compound (3) of the ceramic material (5),
characterized in that,
there is at least one glass material (4) for forming a glass-ceramic (6) which includes the ceramic material (5).

2. The plastics mass as claimed in claim 1, in which the organic starting compound (2) includes a polyorganosiloxane.

3. The plastics mass as claimed in claim 1 or 2, in which the glass material (4) and/or the glass-ceramic (6) include(s) a glass with a glass point Tg which is higher than a decomposition temperature Tz of the organic starting compound (2) of the ceramic material (5).

4. The plastics mass as claimed in one of claims 1 to 3, in which the ceramic material (5) and/or the glass-ceramic (6), within a defined temperature range, have/has a greater specific volume and/or a higher coefficient of thermal expansion than the organic starting compound (2) and/or the inorganic starting compound (3) of the ceramic material (5).

5. The plastics mass as claimed in one of claims 1 to 4, in which the ceramic material (5) and/or the inorganic starting compound (3) of the ceramic material (5) and/or the glass material (4) include(s) at least one substance which is selected from the group consisting of Al, Ba, B, C, Ca, K, Mg, Na, N, O, Si and/or Zr.

6. The plastics mass as claimed in one of claims 1 to 5, in which the inorganic starting compound (3) and the glass material (4) are an inorganic phase (11) of the plastics mass, and the glass material (4) forms from 10% by volume to 50% by volume inclusive of the inorganic phase (11).

7. The plastics mass as claimed in one of claims 1 to 6, in which the glass material includes the inorganic starting compound (3) of the ceramic material (5).

8. The plastics mass as claimed in one of claims 1 to 7, in which the glass material (4) is a powder.

9. The plastics mass as claimed in one of claims 1 to 8, in which the ceramic material (5) is a silicate.

10. The plastics mass as claimed in claim 9, in which the silicate is selected from the group consisting of andalusite, celsian, cristoballite, cordierite, kyanite, mullite and/or silimanite.

11. The use of the plastics mass as claimed in one of claims 1 to 10 for producing a glass-ceramic (6).

12. An electrical engineering product which includes the plastics mass as claimed in one of claims 1 to 10 for electrical insulation of the product.

13. The product as claimed in claim 12, wherein the product is a cable core (8) of a cable (7) and the plastics mass (1) is a cable sheath (9) of the cable (7).
